(19) United States
(12) Patent Application Publication
(10) Pub. No.: US 2008/0083490 A1
(43) Pub. Date: Apr. 10, 2008

(54) FUSING MULTIPLE SHEETS OF POLYMERIC FILM

(75) Inventors: Patrick C. Howard, Austin, TX (US); Kevin L. Gassaway, Cedar Park, TX (US); Charles Mitchell, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/538,710

(22) Filed: Oct. 4, 2006

(51) Int. Cl. B32B 37/00

(52) U.S. Cl. 156/272.8; 156/285; 156/379.6

(57) ABSTRACT

A method of forming a bladder for use in an occupant sensor includes positioning first and second sheets of polymeric film onto a bed. The method further includes positioning a laser beam generator above the bed. The laser beam generator is provided information to describe a path of movement over the bed and is then caused to move over the bed along the path and apply a laser beam to melt the first and second sheets to form a bond between the sheets. A system for manufacturing an occupant sensor bladder from polymeric material is also provided. The system includes a bed capable of accepting two layers of polymeric material and a laser beam generator directed at the bed. The laser beam generator can move along a path above the bed and simultaneously apply a laser beam to the polymeric material.

The present invention is related to occupant sensors. More particularly, the present invention is related to the manufacture of weight sensitive occupant sensors. Sensor assemblies may be used to recognize and monitor the position, orientation, presence, or a size of a person or object within a defined space. As an example, a sensor assembly may be used in a vehicle seat to recognize a person or object located within that seat. One type of technology that is used to perform such sensing is a weight sensing device. One type of weight-based sensing device includes a bladder filled with filler material that is used to measure the mass of a seat occupant. The bladder is formed from two or more sheets of a polymeric material such as a polyether-polyurethane film. Fabrication of a bladder of this type can be performed by positioning two or more pieces of the film in a customized template, and applying heat to those portions of the film not covered by the template to melt the two or more pieces of film together and form a seal.

### SUMMARY

In one aspect, the invention relates to a method of forming a bladder for use in an occupant sensor. The method includes positioning first and second sheets of a polymeric film and positioning the sheets onto a bed or table. A laser beam generator is provided that includes information describing a first path of movement over the first and second sheets. The laser beam generator is positioned with respect to the bed so that the laser beam generator is a first distance from the top surface of the bed. The method causes the laser beam generator to move along the first path and apply a laser beam over at least part of the first path to cause the first and second sheets to melt and form a bond along the part of the first path where the laser beam is applied.

Additionally, the method can include providing information to the laser beam generator describing a second path of desired movement over the bed. The laser beam generator is then cause to move over the bed along the second path and generate a laser beam while the laser beam generator moves along the second path to cut the first and second sheets and form the exterior perimeter of the bladder.

Another aspect of the invention relates to a method of manufacturing a sensor assembly capable of sensing the weight of an occupant. This aspect of the invention includes forming a bladder and attaching at least one occupant sensor to the bladder. The bladder is formed by positioning a first sheet of polymeric film onto a bed adapted to accept the first sheet and positioning a second sheet of polymeric film onto the first sheet. A laser beam is applied to the first and second sheets along a portion of a first path to cause the first and second sheets to melt together along the first path where the laser beam is applied leaving a gap along the first path where the first and second sheets are not melted together. The laser beam is also applied to the first and second sheets along a second path to cause the first and second sheets to be cut along the second path. Material is introduced through the gap and then heat is applied to the gap to melt the first and second sheets together and seal the material between the first and second sheets.

Still another aspect of the invention relates to a system that is configured to manufacture a bladder intended to be used in an occupant sensor. The system includes a bed having a top surface capable of accepting at least layers of polymeric material intended to be manufactured into the bladder. In addition, the system includes a laser beam generator positioned at a distance above and directed at the top surface of the bed and capable of applying a laser beam to the layers of polymeric material. The laser beam generator is configured to move along a length and a width of the top surface of the bed respect to the bed so as to be capable of being positioned over at least a substantial portion of the bed. The laser beam generator is also capable of receiving and storing programming information describing at least one path for the laser beam generator to travel over the bed and describing where along the at least one path to apply the laser beam.

The above summary is not intended to describe each disclosed embodiment or every implementation of the present invention. The figures and detailed description that follow more particularly exemplify illustrative embodiments.

### BRIEF DESCRIPTION OF THE DRAWINGS

The concepts presented herein will be further explained with reference to the attached figures, wherein like structure or system elements can be referred to by like reference numerals throughout the several views.

FIG. 1A illustrates a plan view of a bladder for use in a weight sensor of the type advantageously suited for manufacture using a method or system of the current invention.

FIG. 1B illustrates a side elevation view of the bladder of FIG. 1A.

FIG. 2A is a schematic representation of a side elevation view of a system including a laser member for performing a portion of the manufacturing process of the bladder of FIG. 1 according to one embodiment of the invention.

FIG. 2B is a top view of the schematic of a fixture of FIG. 2A.

FIG. 2C is a cross sectional view of the laser member taken along 2C-2C in FIG. 2A, showing an annular region surrounding a laser beam generator.

FIG. 3 is a schematic detailing components of the laser member of FIG. 2A.

FIG. 4A is a top view of the system illustrating a plurality of bladder sites to be formed by the laser member of FIG. 2A.

FIG. 4B is a detailed schematic of one of the plurality of bladder sites of FIG. 4A.

FIG. 5 is a flowchart illustrating a method of using a laser member to melt and cut a plurality of sheets of polymeric material to form bladders of the type shown in FIG. 1A according to one embodiment of the invention.

While the above-identified figures set forth several embodiments of the present invention, other embodiments are also contemplated, as noted herein. In all cases, concepts presented herein describe the invention by way of representation and not by limitation. It should be understood that numerous other modifications and embodiments can be devised by those skilled in the art which fall within the scope and spirit of the principles of this invention.

### DETAILED DESCRIPTION

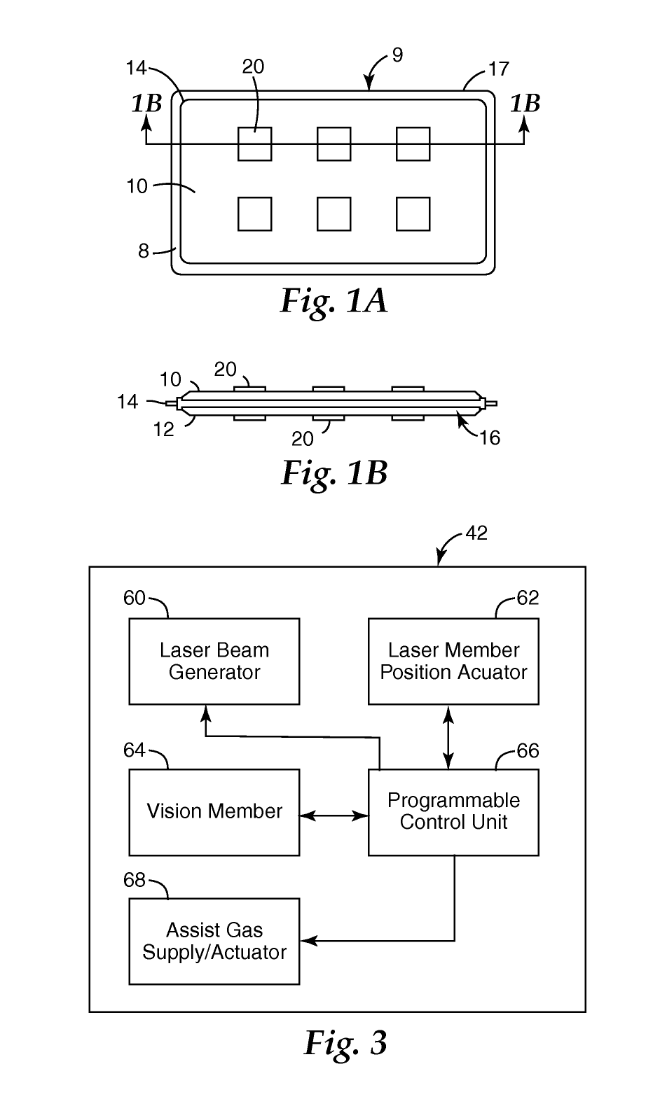

FIGS. 1A and 1B illustrate a bladder 8 for use in a weight sensor 9 of the type advantageously suited for manufacture using a system and/or method of the current invention. Bladder 8 includes a first sheet 10 made of a material such as a polyether or polyurethane film or another waterproof polymeric material suitable for use as a bladder for a weight sensor. Bladder 8 also includes a second sheet 12 of film made from a similar material as that of the first sheet 10. The first sheet 10 is bonded to the second sheet 12 along a bond pattern 14 that defines an inner volume 16. Bond pattern 14 provides a waterproof seal, so that volume 16 is sealed and isolated from an outer surface 18 of bladder 8. In one embodiment, shown in FIG. 1A, the bond pattern 14 is a continuous pattern that extends around the bladder 8 near an outer perimeter 17 of the bladder. Alternatively, the bond pattern 14, while defining the inner volume 16 such that the inner volume is sealed, can take any shape along the bladder 8. Cushioning materials, such as silicone or other suitable cushioning materials (not shown), may be placed within the volume 16 of the bladder 8 to provide the weight sensor 9 with a cushioning effect. In addition, one or more sensing elements 20 can be disposed along the outer surface 18 of bladder 8 or, alternatively, within the inner volume 16 to sense any weight that is imposing a force onto the weight sensor 9. Bladder 8 can have a bond pattern 14 that varies from the pattern shown. For example, a single bladder 8 can have a bonding pattern 14 that creates a plurality of inner volumes (not shown) within the bladder 8 that are mutually exclusive from each other. In addition, the bond pattern 14 can create irregularly shaped volumes, which restrict the amount of filler material capable of being stored within particular portions of the bladder 8.

The sensing elements 20 incorporated in the weight sensor 9 can utilize any suitable technology. For example, sensing elements 20 that approximate capacitive plates may be located on either side of the bladder 8 and as a weight is applied to the bladder 8, subsequent compression of the material within the bladder can cause a change the distance between the sensing elements 20 and a corresponding change in an output signal from the sensing elements 20. Other examples of suitable technologies for sensing elements 20 include strain gauges and inductive sensing devices. These examples are not meant to be limiting but rather are meant to be illustrative. Bladder 8, while shown in FIG. 1A, as having a generally rectangular shape, can be formed of any shape. In addition, although bladder 8, in one embodiment, occupies an area of about 256 square inches, the bladder 8 can be any suitable size. In addition the weight sensor 9 can have any number of sensing elements attached or in communication with a bladder 8, either on the outer surface 18 or within the inner volume 16.

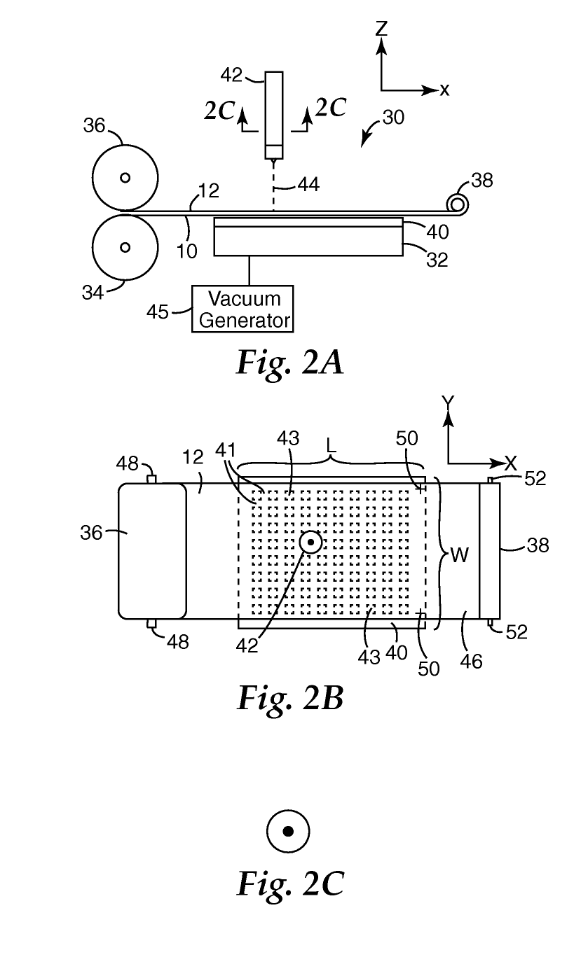

FIGS. 2A and 2B illustrate side and top views, respectively, of a schematic representation of a system 30 adapted to use a laser member 42 to manufacture a plurality bladders 8 of the type shown in FIG. 1A. System 30 includes a bed 32 having a generally planar top surface 40 that is sized and shaped to accept a first sheet 10 of bladder material dispensed from a first dispensing roll 34. For the purposes of this specification, the bed 32 has a width W along the Y axis and a length L along the X axis shown in FIG. 2B. In one embodiment, the top surface 40 of the bed 32 has a length of about four feet and a width of about four feet, although the top surface is not limited to any particular length or width, as long as the top surface is capable of accepting the first sheet 10 of bladder material. The top surface 40 is formed from a metal material so that it is capable of reflecting energy from the laser member 42 back into the first and second sheets 10 and 12. In one embodiment, top surface 40 is an aluminum surface with a web of walls 41 between a pattern of apertures 43 formed therethrough to create a honeycomb effect. Alternatively, the top surface 40 may be a sheet of aluminum without the large apertures 43 that create the honeycomb effect. The top surface 40 may be anodized. Alternatively still, the top surface 40 may be a sheet of copper.

The second sheet 12 of bladder material is positioned above the first sheet 10 of bladder material when the first and second sheets 10 and 12 are extended across the top surface 40 of bed 32. In one embodiment, the second sheet 12 is dispensed from second dispensing roll 36 across the first sheet 10. As seen in FIG. 2B, the second dispensing roll 36 includes a pair of trunnions 48, which are adapted to be engaged with a fixture (not shown) capable of supporting the trunnions 48 and allowing the second dispensing roll 36 to rotate and dispense the second sheet 12 of bladder material onto the top surface 40 of bed 32. Although not shown, the first dispensing roll 34 can have a similar support and dispensing arrangement. While the embodiments illustrated and discussed here involve the use of first and second sheets 10 and 12 of bladder material, it should be appreciated that more than two sheets of bladder material can be used without departing from the scope of the invention.

A receiving roll 38 is disposed on the opposite side of the top surface 40 of table 32 from the first and second dispensing rolls 34 and 36. The receiving roll 38 is positioned to accept a processed portion 46 of the first and second sheets 10 and 12 (that is, portions of the first and second sheets 10 and 12 that have been processed on the bed 32 so that bladders 8 have been at least partially formed). The processed portion 46 is then rolled up onto the receiving roll 38. Receiving roll 38 includes a pair of trunnions 52 extending from opposite ends of the receiving roll. Receiving roll 38 is configured to be attached to a fixture (not shown), which can engage the trunnions 52 to pull the processed portion 46 toward the receiving roll 38 and correspondingly, pull the first and second sheets 10 and 12 from the first and second dispensing rolls 34 and 36 across the top surface 40 of bed 32.

First and second receiving rolls 34 and 36 and receiving roll 38 are shown as being positioned so as to properly position the first and second sheets 10 and 12 onto the top surface 40 of bed 32. However, the first and second dispensing rolls 34 and 36 and receiving roll 38 may not be positioned thusly, nor may positioning of the first and second dispensing rolls 34 and 36 and receiving roll 38 alone be enough to properly align first and second sheets 10 and 12 along the top surface 40. Thus, one or more positioning and or tensioning devices such as rollers (not shown) maybe positioned on either the side of the bed 32 where the dispensing rolls 34 and 36 are positioned or the side of the bed 32 where the receiving roll 38 is positioned, or both.

FIGS. 2A and 2B show one embodiment of a system 30 having first and second dispensing rolls 34 and 36 that provide continuous first and second sheets 10 and 12 of bladder material to be positioned over the top surface 40 of bed 32. Alternatively, pre-cut first and second sheets (not shown) that are sized to fit onto the top surface 40 can be positioned over the bed 32 for processing and removed manually or otherwise after they have been processed. In addition, other systems and methods of positioning first and second sheets 10 and 12 of bladder material onto the top surface 40 of bed 32 can be employed.

Once the first and second sheets 10 and 12 have been positioned onto the top surface 40 of bed 32, it is advantageous to properly secure the sheets 10 and 12 prior to processing the sheets 11 and 12 with the laser member 42. In one embodiment, bed 32 can include or be attached to a vacuum generator 45 capable of drawing a vacuum between the top surface 40 and the first sheet 10 through a series of small apertures (not shown) disposed along the top surface 40. For example, the top surface 40 can include a one inch by one inch grid of apertures having a diameter of about 1/16 of an inch disposed across the top surface 40. Other patterns and sizes of apertures can be implemented. For example, when the top surface 40 includes a honeycomb pattern as discussed above, small apertures may be formed into the walls 41. By employing a vacuum to draw the first sheet 10 to the top surface 42, the first sheet can be smoothed to reduce the likelihood of wrinkles forming into bladders 8 causing them to be improperly or inadequately sealed. In addition, the first sheet 10 can include a series of apertures (not shown) extending through it in strategic positions, that is, in areas of the first sheet 10 that will not be a part of any bladder 8, to provide a vacuum to draw the second sheet 12 onto the first sheet 10.

As mentioned above, system 30 includes a laser member 42, which is positioned above the top surface 40 of bed 32. Laser member 42 is employed to provide sufficient energy to melt the first and second sheets 10 and 12 together along a predetermined path to form at least a portion of the bond pattern 14 of each bladder 8. In addition, laser member 42 is also employed to provide sufficient energy to cut the first and second sheets 10 and 12 along at least a portion of the perimeter 17 (shown in FIG. 1A) of each bladder 8. The process of using the laser member 42 will be described in more detail below.

Referring to FIG. 3, laser member 42, in one embodiment, includes a laser beam generator 60, capable of providing a laser beam 44 (shown in FIG. 2A) to perform the melting and cutting functions. In one embodiment, laser beam generator 60 is a carbon dioxide laser, although other acceptable types of lasers can be used. Laser beam generator 60 is a variable output device, capable of supplying a laser beam 44 with varying levels of power.

Laser member 42 also includes a programmable control unit 66, which is capable of receiving programming information to control the laser member 42. For example, programmable control unit, in one embodiment, can cause the laser beam generator 60 to vary the output power of the laser beam 44 as it becomes advantageous to do so. Laser member 42 also includes a laser member positioning actuator 62, which is capable of moving the laser member 42. In one embodiment, the positioning actuator 62 is capable of moving the laser member 42 along at least a portion of the length L and the width W (as defined in FIG. 2B). Alternatively, the positioning actuator 62 is capable of moving the laser member in the Z-direction (as defined in FIG. 2A). By moving the laser member in the Z-direction, the position of the focal point of the laser beam 44 as it relates to the surface of top sheet 10 can be adjusted. Other techniques can be used to change the relative position of the focal point of the laser beam 44. For example, the optical lens used in the laser beam generator 60 can be changed or the bed 32 can be moved in the Z-direction.

Laser member 42 also includes, in one embodiment, a vision member 64 that is capable of creating and detecting visual indicators on the first and/or second sheets 10 and 12. For example, FIG. 2B shows a pair of fiducial or registration marks 50 on the second sheet 12. Vision member 64 is capable of detecting the fiducial marks 50 and transmitting that information to the programmable control unit 66 to orient the laser member 42 with respect to the top surface 40 of the bed 32 as well as the first and second sheets 10 and 12 that are disposed thereon. Vision member 64 is also capable of creating fiducial marks 50 onto the second sheet 12 if it is advantageous to do so.

Laser member 42 further includes, in one embodiment, an assist gas supply/actuator 68. Assist gas can be applied during the process of generating a laser beam 44 to advantageously diffuse smoke or particles that may accrue during the process of providing a laser beam 44 to cut or melt the first and second sheets 10 and 12. By diffusing the smoke and/or particles, the welding and cutting processes can become more predictable by allowing the vision member 64, for example, to provide a more precise location of the laser member 42 as it traverses the top surface 40 of bed 32. In addition, the assist gas can apply pressure onto the second sheet 12 to assist in holding it in proper position so as to minimize wrinkles or other imperfections from being formed into the bladder 8. Programmable control unit 66, in one embodiment, is capable of controlling whether the assist gas supply 68 is to be activated as well as varying the amount and pressure of the assist gas that is supplied. Referring briefly to FIG. 2C, an annular region 69 is shown surrounding the laser beam generator 60 within the laser member 42. The assist gas supply 68 supplies assist gas into and through the annular region 69 and onto the second sheet 12.

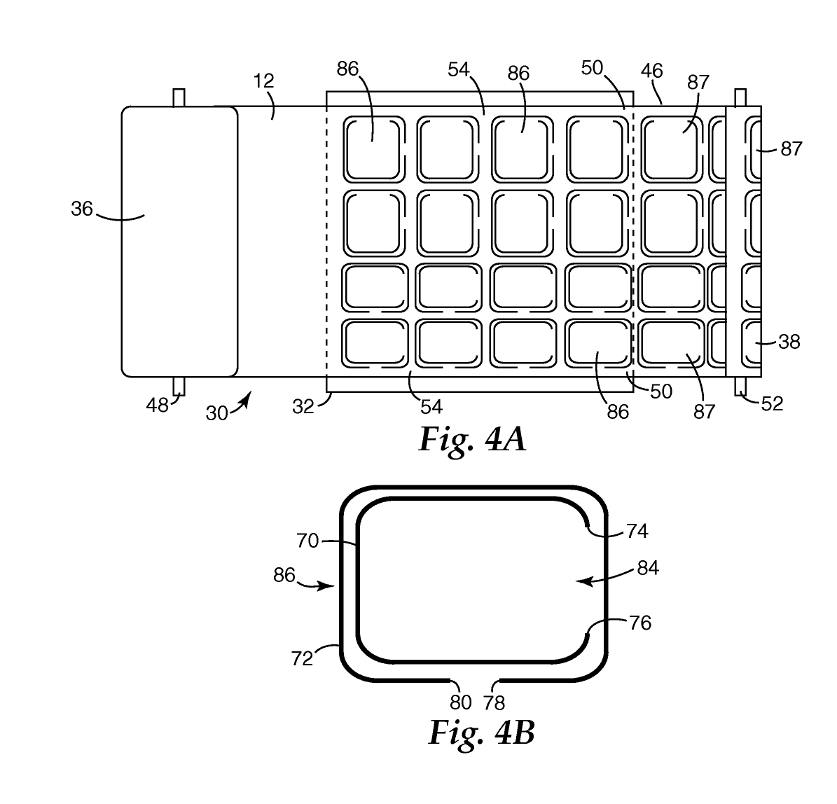

As described above, in one embodiment, the top surface 40 has a length of about four feet and a width of about four feet. By contrast, one embodiment of the bladder 8 has an area of about 256 square inches. While it should be appreciated that these dimensions can vary even substantially, it should also be appreciated that a plurality of bladders 8 can fit on the top surface 40 of the bed 32 simultaneously. Accordingly, more than one bladder 8 can be formed from a portion of the first and second sheets 10 and 12 positioned on the top surface 40. Referring to FIGS. 4A and 4B, system 30 is shown with a plurality of bladder sites 86 from which a plurality of bladders 8 can formed between the first and second sheets 10 and 12 as they are positioned on the top surface 40 of bed 32. Each of the bladder sites 86 shown has a melt pattern 70 and a cut pattern 72. It should be appreciated that the melt pattern 70 corresponds to and is a portion of the bonding pattern 14 of a completed bladder 8. The bladder sites 86 are shown having a differing sizes and shapes. As shown, the bladder sites 86 can be arranged such that the bladder sites 86 have different orientations with respect to the top surface 40. While it is advantageous to arrange the bladder sites 86 to use a maximum amount of the first and second sheets 10 and 12 of bladder material, there will be some waste material or spoil 54 between the bladder sites 86 will not be a part of any bladder 8.

A certain amount of spoil 54 can be advantageous. For example, as can be seen, when the laser member 42 (not shown in FIG. 4A) cuts the first and second sheets 10 and 12 along the cut patterns 72 at each of the bladder sites 86, the resultant partially formed bladders 8 are still attached to the spoil 54. As the processed portion 46 is moved off of the bed 32 and onto the receiving roll 38, the partially formed bladders 87 remain attached to the spoil 54. Eventually, the entire amount of material provided by the first and second dispensing rolls 34 and 36 will have been processed, and the processed portion 46 will include the entire first and second sheets 10 and 12. The processed portion 46 will have then been rolled onto the receiving roll 38. Receiving roll 38 can then be unrolled to perform additional processes onto the partially formed bladders 87 such as adding sensor elements 20. By having the partially formed bladders 87 attached to the spoil 54, such additional processes can be more easily achieved. In addition, as mentioned above, the bed 32 can includes a vacuum generator 45 and adding apertures (not shown) into strategically placed locations on first sheet 10 can draw a vacuum between the top surface 40 and the second sheet 12 to draw the second sheet 12 to the first sheet 10. Thus, these holes can be placed into locations on first sheet 10 known to eventually be part of the spoil 54.

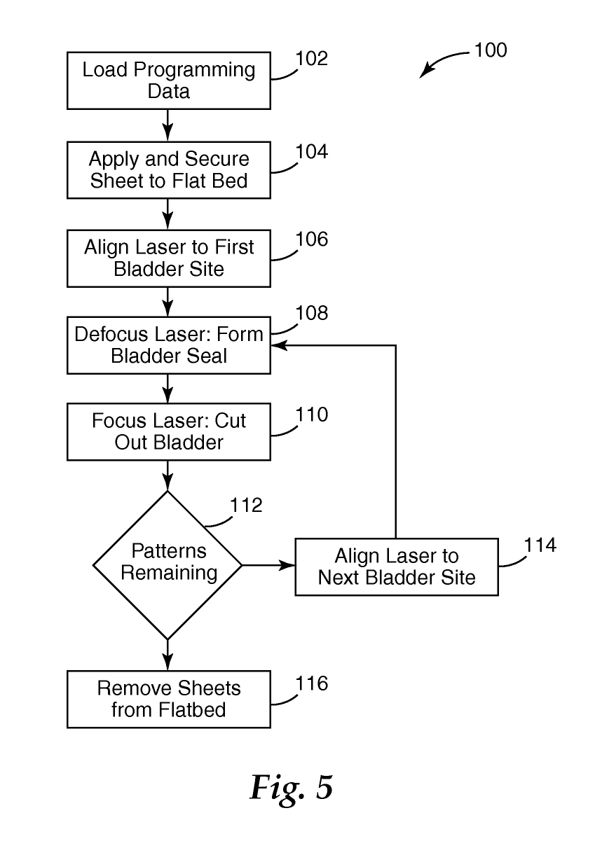

FIG. 5 illustrates a method 100 for forming the partially formed bladder 87 from first and second sheets 10 and 12 of polymeric material. Method 100 begins by loading programming data into the programmable control unit 66 of laser member 42. The program loaded into the programmable control unit includes information including the paths for the laser member 42 to travel (such as the melt pattern 70 and the cut pattern 72 for each of the bladders 8) to travel and the speed at which the laser member should move along the paths. In addition, the program includes information regarding when the laser beam generator 60 should supply a laser beam 44 and at what power level the beam should be supplied. Further, the program can include information as to whether the laser beam 44 should be “focused” or “defocused” on the first and second sheets 10 and 12. When the laser beam 44 is focused on the first and second sheets 10 and 12, more heat is generated per unit area, which may cause the first and second sheets 10 and 12 to be cut by supplying enough energy to vaporize the material that comes into contact with laser beam 44. Thus, when traversing the cut pattern 72, it may be advantageous to have the laser focused. Conversely, when it is desirable to melt the first and second sheets 10 and 12 rather than cut them, defocusing the laser beam 44 may reduce the heat per unit area and thereby melt, rather than cut the first and second sheets 10 and 12. By changing the distance between the laser beam generator 60 and the first and second sheets 10 and 12, the focal point can be positioned on the first and second sheets 10 and 12, that is, focused, or away from the first and second sheets 10 and 12, that is, unfocused. In one embodiment, for example, the programmable control unit 66 may provide information to bed 32 to cause bed 32 to move in the Z-direction to defocus or refocus the laser beam 44.

Once the step 102 of loading the program into the programmable control unit 66 of laser member 42 is completed, the first and second sheets 10 and 12 are applied and secured to the bed 32, as shown in block 104. As discussed above, bed 32, in one embodiment, provides a vacuum to secure the first sheet 10 and possibly second sheet 12 to the top surface 40 of the bed 32. As is shown in FIGS. 2A and 2B, first and second sheets 10 and 12 can be supplied onto the top surface 40 of bed 32 by first and second dispensing rolls 34 and 36. The first and second sheets 10 and 12 are pulled from the first and second rolls 34 and 36 by receiving roll 38, which also rolls up the previously formed bladders. Alternatively, first and second sheets 10 and 12 can be discrete sheets previously cut (not shown in any of the figures) and placed on the bed 32.

Once the first and second sheets 10 and 12 have been applied and secured to the top surface 40 of the bed 32, laser member 42 is aligned to begin to traverse a path defined by melt pattern 70 for one of the plurality of bladder sites 86 as is represented by block 106. If none of the bladder sites 86 have been previously traversed, the vision member 64 of laser member 42 finds fiducial marks 50 previously placed on second sheet 12 to orient the laser member 42 with respect to the first and second sheets 10 and 12 and the bed 32. Referring additionally to FIG. 4B, once the laser member 42 has oriented itself with respect to bed 32, it moves to the beginning 74 of the melt pattern 70 for one of the plurality of bladder sites 86. In addition, the laser beam generator 60 is defocused if it had not been already.

Once laser member 42 is properly positioned at the beginning 74 of the melt pattern 70, it travels the melt pattern 70 from the beginning 74 to an end 76. While the positioning actuator 62 is moving the laser member 42 along the melt pattern 70, the laser beam generator 60 generates a laser beam 44 to melt or fuse the first and second sheets 10 and 12 together to form a portion of the bond pattern 14 as is represented by block 108. Assist gas supply 68 can supply a gas to diffuse smoke and/or particles that may collect around the laser beam 44 during the melting process. In addition, the gas supplied by the assist gas supply can apply pressure to the second sheet 12 to hold the second sheet 12 in the proper position. Due to variations in the melt pattern 70 such as corners or curves, it may be necessary to vary the speed at which the positioning actuator 62 moves the laser member 42 and/or the amount of power supplied by the laser beam generator 60 to ensure that the first and second sheets 10 and 12 are properly fused together without being cut. As can be seen in FIG. 4B, when the laser member 42 has traversed the melt pattern 70 from the beginning 74 to end 76, the bond pattern 14 is not completed, leaving a gap 84. The gap 84 provides an opening to allow subsequent insertion of filler materials such as silicone or sensing elements 20 within the bladder 8.

At block 110, the laser member 42 moves to beginning 78 of cut pattern 72 of the particular bladder site 86. The laser beam generator 60 is refocused and positioning actuator 62 then moves the laser member 42 from the beginning 78 to and end 80 of cut pattern 72. While travelling along the cut pattern 72, laser beam generator 60 applies a laser beam 44 of sufficient energy to cut through both the first and second sheets 10 and 12. Similar to the process described above in relation to block 108, the assist gas supply 68 can apply gas. In addition, the speed that the positioning actuator 62 moves the laser member 42 and the amount of power applied by the laser beam generator 60 can vary at various locations along the cut pattern 72. As has been described above, when the laser member 42 has traversed the entire cut pattern 72, a partially formed bladder 87 remains. The partially formed bladder 87 is not completely detached from the first and second sheets 10 and 12.

Once the laser member has melted and cut the first and second layers 10 and 12 to create a partially formed bladder 87 at the current bladder site 86, the programmable control unit 66 of laser member 42 checks to see if an additional bladder sites 86 remain on the top surface 40 had have not yet been traversed to create a partially formed bladder 87, as is represented at block 112. If it is determined that there are additional bladder sites 86 remaining to be traversed by the laser member 42 to create partially formed bladders 87 out of the first and second sheets 10 and 12 as they are currently positioned on bed 32, the laser member 42 is aligned to the beginning 74 of the melt pattern 70 at the next bladder site 85, as is represented at block 114. Then method 100 returns to block 108 to repeat the process at the next bladder site 86. If it is determined that there are no further bladder sites 86 remaining on top surface 40, the first and second sheets 10 and 12 are removed from the bed 32 as represented by block 116. It should be appreciated that although the method 100 describes a method of forming a portion of the bond pattern 14 and then cutting around a portion of the bladder at a single site 86 before moving to another bladder site, an alternative method would include forming the bond pattern 14 for a plurality of or all of the bladder sites 86 before performing the step of cutting the first and second sheets 10 and 12 at any of the bladder sites 86.

In one embodiment, removal of the first and second sheets 10 and 12 from the top surface 40 of bed 32 is accomplished by engaging receiving roll 38 to roll up the now processed material 46 from the top surface 40. Prior to rolling the first and second sheets 10 and 12 onto the receiving roll 38, however, laser member 42 moves to an edge of the bed 32 closest to the distribution rolls 34 and 36. The vision member 64 forms fiducial marks onto the second sheet 12. Once the first and second sheets 10 and 12 are rolled onto the receiving roll 38, the fiducial marks 50 shall be positioned in a location similar to that shown in FIG. 3. At that point method, 100 can be repeated until the rolls 34 and 36 that distribute first and second sheets 10 and 12 are completely exhausted.

Subsequently, the partially formed bladder 87 is cut out of the first and second sheets 10 and 12 and the inner volume 16 can be filled with filler material. Once the partially formed bladder 87 has been properly filled, the gap 84 can be closed through the application of heat from any suitable source such as RF heating to finish the process of forming a bladder 8. Sensing elements 20 can then be attached to the bladder 8 if they have not already be previously attached, as described above.

The embodiments described herein provides several advantages. For example, different shapes and sizes of bladders can be manufactured without requiring the fabrication of a tooling fixture. Simply creating a different path for the laser to travel as it emits its beam, will create a different shape or size of bladder. This allows for rapid development of different sizes and shapes of bladders, as well as the ability to quickly manufacture different sizes and shapes of bladders without changing a tooling fixture. Further, as described above, multiple bladders can be simultaneously formed on the bed.

Although the present invention has been described with reference to several alternative embodiments, workers skilled in the art will recognize that changes may be made in form and detail without departing from the spirit and the scope of the invention.

What is claimed is:

1. A method of forming a bladder for use in an occupant sensor, comprising:
positioning a first sheet of polymeric film onto a bed having a top surface;
positioning a second sheet onto the first sheet;
providing a laser beam generator with information describing a first path of movement over the first and second sheets;
positioning the laser beam generator with respect to the bed so that the laser beam generator is a first distance from the top surface of the bed; and
causing the laser beam generator to move along the first path and apply a laser beam over at least part of the first path to cause the first and second sheets to melt and form a bond along the part of the first path where the laser beam is applied.

2. The method of claim 1, and further comprising:
providing the laser beam generator with information describing a second path of movement over the bed and causing the laser beam generator to move along the second path and apply a laser beam over at least part of the second path to cause the first and second sheets to be cut along the part of the second path where the laser beam is applied.

3. The method of claim 1, and further comprising:
providing a vacuum through the top surface of the bed to draw the first sheet to the top surface.

4. The method of claim 3, wherein the step of providing the vacuum includes providing the vacuum to draw the second sheet to the first sheet.

5. The method of claim 1, wherein the step of causing the laser beam generator to apply a laser beam over at least part of the first path includes providing a laser beam having varying levels of energy over the first path to form the bond.

6. The method of claim 1, wherein the step of causing the laser beam generator to move along the first path includes causing the laser beam generator to move at varying rates of speed along the first path.

7. The method of claim 1, and further comprising:
positioning the laser beam generator with respect to the bed so that the laser beam generator is a second distance from the top surface of the bed.

8. A method of manufacturing a sensor assembly capable of sensing the weight of an occupant, comprising:
forming a bladder, including the steps of:
positioning a first sheet of polymeric film onto a bed adapted to accept the first sheet;
positioning a second sheet of polymeric film onto the first sheet of polymeric film;
applying a laser beam to the first and second sheets along a portion of a first path to cause the first and second sheets to melt together along the first path where the laser beam is applied leaving a gap along the first path where the first and second sheets are not melted together;
applying a laser beam to the first and second sheets along a second path to cause the first and second sheets to be cut along the second path;
introducing material through the gap; and
applying heat to the gap to melt the first and second sheets together to seal the material between the first and second sheets; and
attaching at least one occupant sensor to the bladder.

9. The method of claim 8, wherein the step of applying heat to the gap includes applying a laser beam to the first and second sheets along the gap to cause the first and second sheets to bond together and complete the seal.

10. The method of claim 8, wherein the step of positioning the first sheet onto the bed includes applying a vacuum to the first sheet to pull the first sheet against the bed.

11. The method of claim 8, wherein the step of positioning the second sheet onto the bed includes applying a vacuum to the second sheet to pull the second sheet against the first sheet.

12. The method of claim 8, and further comprising:
introducing a pressurized gas to the second sheet while performing the step of applying a laser beam to the first and second sheets along a portion of the first path.

13. The method of claim 8, and further comprising:
introducing a pressurized gas to the second sheet while performing the step of applying a laser beam to the first and second sheets along the second path.

14. A system configured for manufacturing a bladder used in an occupant sensor, comprising:
a bed having a top surface capable of accepting at least two layers of polymeric material to be manufactured into the bladder; and
a laser beam generator positioned at a distance above and directed at the top surface of the bed and capable of applying a laser beam to the layers of polymeric material, wherein:
the laser beam generator is configured to move along a length and a width of the top surface of the bed respect to the bed so as to be capable of being positioned over at least a substantial portion of the bed; and
the laser beam generator is capable of receiving and storing programming information describing at least one path for the laser beam generator to travel over the bed and describing where along the at least one path to apply the laser beam.

15. The system of claim 14, wherein the laser beam generator is capable of supplying the laser beam at a variable energy level and wherein the programming information includes an energy level at which the laser beam is to be applied at any given point along the at least one path.

16. The system of claim 15, wherein the energy level supplied is sufficient to cut the polymeric material.

17. The system of claim 15, wherein the level of energy capable of being supplied is sufficient to melt layers of the polymeric material together.

18. The system of claim 14, wherein the laser beam generator is capable of moving at a variable rate of speed and wherein the programming information includes the rate of speed at which the laser beam generator is to move at any given point along the at least one path.

19. The system of claim 14, wherein the laser beam generator is capable of moving toward or away from the bed to change the distance between the laser beam generator and the top surface of the bed.

20. The system of claim 14, wherein the bed is capable moving toward or away from the laser beam generator to change the distance between the laser beam generator and the top surface of the bed.

21. The system of claim 14, and further comprising:
a polymeric material dispenser capable of providing the at least two layers of polymeric material onto the top surface of the bed.

22. The system of claim 21, wherein the polymeric material dispenser is further capable of removing the polymeric material from the top surface of the bed.

23. The system of claim 14, wherein the top surface is comprised of aluminum.

24. The system of claim 14, wherein the top surface includes a plurality of apertures extending therethrough and further comprising:
a vacuum generator capable of drawing a vacuum through the plurality of apertures extending through the top surface.
